(19) United States
(12) Patent Application Publication
(10) Pub. No.: US 2025/0117963 A1
(43) Pub. Date: Apr. 10, 2025

(54) PEOPLE FLOW CONTROL EVALUATION APPARATUS, PEOPLE FLOW CONTROL EVALUATION METHOD, AND COMPUTER READABLE MEDIUM

(71) Applicants: Mitsubishi Electric Corporation, Tokyo (JP); The University of Tokyo, Tokyo (JP)

(72) Inventors: Hirofumi NISHIKAWA, Tokyo (JP); Katsuhiro NISHINARI, Tokyo (JP)

(73) Assignees: Mitsubishi Electric Corporation, Tokyo (JP); The University of Tokyo, Tokyo (JP)

(21) Appl. No.: 18/985,810

(22) Filed: Dec. 18, 2024

Related U.S. Application Data
(63) Continuation of application No. PCT/JP2022/031439, filed on Aug. 19, 2022.

(51) Int. Cl. G06T 7/73; G06T 7/246; G06T 7/60; G06V 20/52

(52) U.S. Cl. CPC G06T 7/73; G06T 7/246; G06T 7/60; G06V 20/53; G06T 2207/10016; G06T 2207/30196

(57) ABSTRACT

A people flow control evaluation apparatus (100) evaluates an effect of people flow control. A position obtaining unit (110) extracts a position of a target person chronologically from people flow information (20) and stores the position of the target person as chronological position information (41). A direction calculation unit (120) calculates a movement direction of the target person chronologically based on the chronological position information (41) and stores the movement direction of the target person as a chronological movement direction (42). An effect evaluation unit (130) calculates an angular difference between the movement direction of the target person and a direction towards a destination position from the position of the target person chronologically, and evaluates the effect of the people flow control using a chronological change of the angular difference calculated chronologically.

### CROSS REFERENCE TO RELATED APPLICATION

This application is a Continuation of PCT International Application No. PCT/JP2022/031439, filed on Aug. 19, 2022, which is hereby expressly incorporated by reference into the present application.

### TECHNICAL FIELD

The present disclosure relates to a people flow control evaluation apparatus, a people flow control evaluation method, and a people flow control evaluation program. Specifically, the present disclosure relates to a people flow control evaluation apparatus, a people flow control evaluation method, and a people flow control evaluation program that evaluate an effect of a system that controls or guides people flow.

### BACKGROUND ART

A people flow control system is a system that controls or guides people flow in places where people flow occurs such as a station, a building, or a commercial facility. The people flow control system is also called a people flow guidance system. In recent years, a technique to evaluate people flow control by such people flow control system is used.

Technology to evaluate a people flow control effect of a people flow control system in a station of a railroad or in a building is disclosed in Patent Literature 1. In the technology of Patent Literature 1, a control function is calculated based on people flow information and people flow control information, people flow is simulation processed based on the people flow information and the control function, and the people flow control effect is evaluated based on a people flow simulation result. Here, “congestion degree by area”, “delay time by route”, and “lost time” are used as evaluation values for evaluating the people flow control effect. The “congestion degree by area” is a degree that indicates approximately how many passengers actually exist with respect to the number of people an area defined beforehand within a space can accommodate. The “delay time by route” is a degree that indicates a difference between standard travel time for each origin and destination and actual travel time. The “lost time” is time added of lost time of all combinations of origin and destination and for all passengers over a certain period of time.

### CITATION LIST

### Patent Literature

Patent Literature 1: WO 2017/175551

### SUMMARY OF INVENTION

### Technical Problem

The evaluation value in Patent Literature 1 is possible to measure how the people flow in an entire area is distributed, and how the people flow changed in terms of time. How people flow control given affected an activity change of a person, however, cannot be evaluated. That is, there is an issue where an effect of the people flow control cannot be correctly evaluated.

In the present disclosure, an aim is to more correctly evaluate an effect of people flow control.

### Solution to Problem

A people flow control evaluation apparatus according to the present disclosure evaluates an effect of people flow control that controls people flow towards a destination position. The people flow control evaluation apparatus includes:
a position obtaining unit to extract a position of a target person who is a person included in the people flow chronologically from people flow information that shows people flow on which the people flow control is executed, and to store the position of the target person extracted chronologically as chronological position information;
a direction calculation unit to calculate a movement direction of the target person chronologically based on the chronological position information, and to store the movement direction of the target person calculated chronologically as a chronological movement direction; and
an effect evaluation unit to calculate an angular difference between the movement direction of the target person and a direction towards the destination position from the position of the target person chronologically based on the destination position and the chronological movement direction, and to evaluate the effect of the people flow control using a chronological change of the angular difference calculated chronologically.

### Advantageous Effects of Invention

In the present disclosure, an effect evaluation unit calculates, based on a destination position and a chronological movement direction, an angular difference between a movement direction of a target person and a direction towards the destination position from a position of the target person. Then, the effect evaluation unit evaluates an effect of people flow control using a chronological change of the angular difference calculated chronologically. According to the present disclosure, since whether or not a target person included in people flow on which the people flow control is executed reached the destination position can be shown by the chronological change of the angular difference, the effect of the people flow control can be evaluated more correctly.

### BRIEF DESCRIPTION OF DRAWINGS

FIG. 1 is a diagram illustrating an example of a configuration of a people flow control evaluation apparatus according to Embodiment 1.

FIG. 2 is a flow diagram illustrating operation of the people flow control evaluation apparatus according to Embodiment 1.

FIG. 3 is a schematic view showing a people flow control evaluation process according to Embodiment 1.

FIG. 4 is a diagram illustrating an example of a configuration of a people flow control evaluation apparatus according to a variation of Embodiment 1.

FIG. 5 is a flow diagram illustrating operation of a people flow control evaluation apparatus according to Embodiment 2.

FIG. 6 is a schematic view showing a people flow control evaluation process according to Embodiments 2 to 4.

FIG. 7 is a flow diagram illustrating operation of a people flow control evaluation apparatus according to Embodiment 3.

FIG. 8 is a flow diagram illustrating operation of a people flow control evaluation apparatus according to Embodiment 4.

### DESCRIPTION OF EMBODIMENTS

The present embodiments will be described below using diagrams. In each diagram, same reference signs are added to same or equivalent portions. In a description of the embodiments, a description of the same or equivalent portions will be suitably omitted or simplified. Arrows in the diagrams mainly indicate flows of data or flows of processes. In the diagrams below, there is a case where a relationship in size of each component member differ from an actual component member. In the description of the embodiments, there is a case where an orientation or a position is indicated such as top, bottom, left, right, front, back, outside, and inside. These notations are for convenience of description and do not limit an arrangement, a direction, and an orientation of an apparatus, an instrument, a part, or the like.

### Embodiment 1

### ***Description of Configuration***

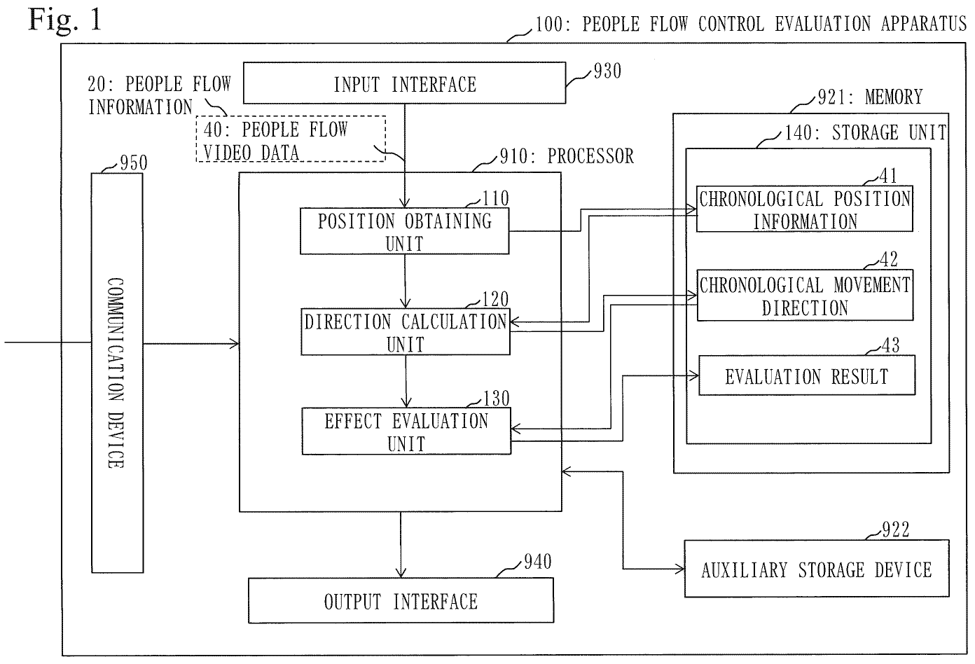

FIG. 1 is a diagram illustrating an example of a configuration of a people flow control evaluation apparatus 100 according to the present embodiment.

The people flow control evaluation apparatus 100 is an apparatus that evaluates an effect of people flow control when the people flow control is executed for a people flow towards a destination position. The people flow control is also called people flow guidance.

The people flow control evaluation apparatus 100 is a computer. The people flow control evaluation apparatus 100 includes a processor 910 and other hardware such as a memory 921, an auxiliary storage device 922, an input interface 930, an output interface 940, and a communication device 950. The processor 910 is connected to other hardware through a signal line, and controls these other pieces of hardware.

The people flow control evaluation apparatus 100 includes, as functional elements, a position obtaining unit 110, a direction calculation unit 120, an effect evaluation unit 130, and a storage unit 140. Chronological position information 41, a chronological movement direction 42, and an evaluation result 43 are stored in the storage unit 140. Although not illustrated, destination position O of the people flow is stored in the storage unit 140 beforehand. Destination position O is a destination to where the people flow is controlled or guided. Destination position O is represented by position information or a range of the position information.

Functions of the position obtaining unit 110, the direction calculation unit 120, and the effect evaluation unit 130 are enabled by software. The storage unit 140 is included in the memory 921. The storage unit 140 may be included in the auxiliary storage device 922, or may be included by being distributed in the memory 921 and the auxiliary storage device 922.

The processor 910 is a device that executes a people flow control evaluation program. The people flow control evaluation program is a program that enables the functions of the position obtaining unit 110, the direction calculation unit 120, and the effect evaluation unit 130.

In the present embodiment, for example, an image processing processor is used as the processor 910.

The processor 910 is an IC that performs a calculation process. Specific examples of the processor 910 are a CPU, a DSP, and a GPU. IC is an abbreviation for Integrated Circuit. CPU is an abbreviation for Central Processing Unit. DSP is an abbreviation for Digital Signal Processor. GPU is an abbreviation for Graphics Processing Unit.

The memory 921 is a storage device that stores data temporarily. A specific example of the memory 921 is an SRAM or a DRAM. SRAM is an abbreviation for Static Random Access Memory. DRAM is an abbreviation for Dynamic Random Access Memory.

The auxiliary storage device 922 is a storage device that stores data. A specific example of the auxiliary storage device 922 is an HDD. The auxiliary storage device 922 may be a portable storage medium such as an SD (registered trademark) memory card, a CF, a NAND flash, a flexible disc, an optical disc, a compact disc, a Blu-ray (registered trademark) disc, or a DVD. HDD is an abbreviation for Hard Disk Drive. SD (registered trademark) is an abbreviation for Secure Digital. CF is an abbreviation for CompactFlash (registered trademark). DVD is an abbreviation for Digital Versatile Disk.

The input interface 930 is a port connected to an input device such as a mouse, a keyboard, or a touch panel. The input interface 930, specifically, is a USB terminal. The input interface 930 may be a port connected to a LAN. USB is an abbreviation for Universal Serial Bus. LAN is an abbreviation for Local Area Network. One input interface 930 is illustrated in FIG. 1, but a plurality of input interfaces 930 may exist.

In the present embodiment, the present embodiment has an image input interface as the input interface 930. The position obtaining unit 110 of the people flow control evaluation apparatus 100 obtains people flow video data 40 through the image input interface.

The output interface 940 is a port to which a cable of an output device such as a display is connected. The output interface 940, specifically, is a USB terminal or an HDMI (registered trademark) terminal. The display, specifically, is an LCD. The output interface 940 is also called a display interface. HDMI (registered trademark) is an abbreviation for High Definition Multimedia Interface. LCD is an abbreviation for Liquid Crystal Display. One output interface 940 is illustrated in FIG. 1, but a plurality of output interfaces 940 may exist.

The communication device 950 has a receiver and a transmitter. The communication device 950 is connected to a communications network such as the LAN, the Internet, or a telephone line. The communication device 950, specifically, is a communication chip or an NIC. The communication device 950 is also called a network interface.

The people flow control evaluation program is executed in the people flow control evaluation apparatus 100. The people flow control evaluation program is read into the processor 910, and executed by the processor 910. Not only the people flow control evaluation program but also an OS is stored in the memory 921. OS is an abbreviation for Operating System. The processor 910 executes the people flow control evaluation program while executing the OS. The people flow control evaluation program and the OS may be stored in the auxiliary storage device 922. The people flow control evaluation program and the OS stored in the auxiliary storage device 922 are loaded into the memory 921 and executed by the processor 910. A part or all of the people flow control evaluation program may be built into the OS.

The people flow control evaluation apparatus 100 may include a plurality of processors that replace the processor 910. These plurality of processors share execution of the people flow control evaluation program. Each processor, as with the processor 910, is a device that executes the people flow control evaluation program.

Data, information, signal values, and variable values utilized, processed, or outputted by the people flow control evaluation program are stored in the memory 921, the auxiliary storage device 922, or a register or a cache memory in the processor 910.

“Unit” of each unit of the position obtaining unit 110, the direction calculation unit 120, and the effect evaluation unit 130 may be replaced with “circuit”, “step”, “procedure”, “process”, or “circuitry”. The people flow control evaluation program causes a computer to execute a position obtaining process, a direction calculation process, and an effect evaluation process. “Process” of the position obtaining process, the direction calculation process, and the effect evaluation process may be replaced with “program”, “program product”, “computer-readable storage medium having stored a program”, or “computer-readable recording medium having recorded a program”. A people flow control evaluation method is a method performed by the people flow control evaluation apparatus 100 executing the people flow control evaluation program.

The people flow control evaluation program may be provided being stored in a computer-readable recording medium. The people flow control evaluation program may be provided as a program product.

### ***Description of Operation***

Next, a people flow control evaluation process that is operation of the people flow control evaluation apparatus 100 according to the present embodiment will be described. An operation procedure of the people flow control evaluation apparatus 100 is equivalent to the people flow control evaluation method. A program that enables the operation of the people flow control evaluation apparatus 100 is equivalent to the people flow control evaluation program.

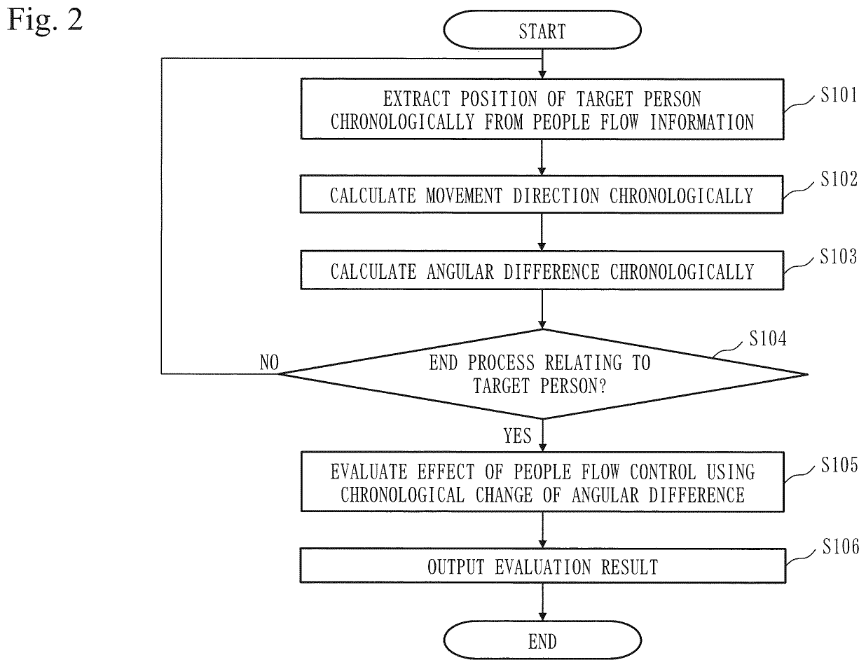

FIG. 2 is a flow diagram illustrating the operation of the people flow control evaluation apparatus 100 according to the present embodiment.

The people flow control evaluation apparatus 100 evaluates an effect of people flow control that controls people flow towards destination position O.

### <Position Obtaining Process>

In step S101, the position obtaining unit 110 extracts a position of a target person included in the people flow chronologically from people flow information 20 that shows the people flow on which the people flow control is executed, and stores the position of the target person extracted chronologically in the storage unit 140 as the chronological position information 41.

The people flow information 20, specifically, is the people flow video data 40 that is the people flow on which the people flow control is being executed filmed.

Specifically, the position obtaining process is as follows.

The position obtaining unit 110 obtains the people flow video data 40 through the input interface 930. The position obtaining unit 110 extracts the position of the target person chronologically from the people flow video data 40 by the processor 910, and stores the position of the target person in the chronological position information 41 of the storage unit 140.

The target person is a person included in the people flow on which the people flow control is being executed.

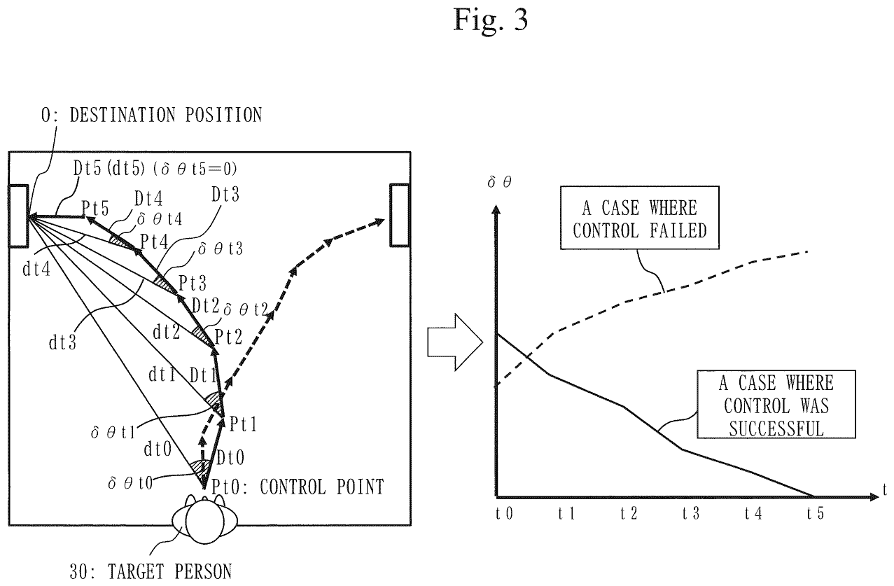

FIG. 3 is a schematic view showing the people flow control evaluation process according to the present embodiment.

In a left diagram of FIG. 3, each of a solid line and a dotted line represent a movement of the target person. Position Pt0 of a target person 30 is a control point. The control point is a position on which some kind of control is executed on the people flow. The control is also called guidance. A target person 30 of the solid line indicates that destination position O is reached. A target person 30 of the dotted line indicates that destination position O is not reached.

Here, the target person 30 of the solid line will be described. The position obtaining unit 110, with regard to the target person 30, extracts chronologically and stores positions Pt0, Pt1, Pt2, Pt3, Pt4, and Pt5 in the chronological position information 41.

### <Direction Calculation Process>

In step S102, the direction calculation unit 120 calculates by the processor 910, a movement direction of the target person 30 chronologically based on the chronological position information 41. The direction calculation unit 120 stores the movement direction of the target person 30 calculated chronologically in the storage unit 140 as the chronological movement direction 42.

Specifically, the direction calculation process is as follows.

Although not illustrated, destination position O is regarded as being stored in the storage unit 140 beforehand as mentioned above.

The direction calculation unit 120 calculates a movement direction at each position using the chronological position information 41. In an example of the left diagram of FIG. 3, the direction calculation unit 120 calculates movement directions Dt0, Dt1, Dt2, Dt3, Dt4, and Dt5 at each position using Pt0, Pt1, Pt2, Pt3, Pt4, and Pt5 stored in the chronological position information 41. In the example of the left diagram of FIG. 3, arrows in the solid line represent movement directions Dt0, Dt1, Dt2, Dt3, Dt4, and Dt5 at each position. The direction calculation unit 120 stores chronological movement directions Dt0, Dt1, Dt2, Dt3, Dt4, and Dt5 in the chronological movement direction 42.

### <Effect Evaluation Process>

In step S103, the effect evaluation unit 130 calculates by the processor 910, angular difference δθ between the movement direction of the target person 30 and a direction towards destination position O from the position of the target person 30 chronologically based on destination position O and the chronological movement direction 42.

In the example of the left diagram of FIG. 3, the effect evaluation unit 130 calculates directions dt0, dt1, dt2, dt3, dt4, and dt5 towards destination position O from each position Pt0, Pt1, Pt2, Pt3, Pt4, and Pt5. Then, the effect evaluation unit 130 calculates angular differences δθ between movement directions Dt0, Dt1, Dt2, Dt3, Dt4, and Dt5 and directions dt0, dt1, dt2, dt3, dt4, and dt5 towards destination position O. The angular differences are δθt0, δθt1, δθt2, δθt3, δθt4, and δθt5 in the left diagram of FIG. 3.

In step S104, the effect evaluation unit 130 verifies whether or not to end a process of the target person included in the people flow.

In a case where the process of the target person is to end, the process proceeds to step S105.

In a case where the process of the target person is not to end, the process returns to step S101, and processes from step S101 to step S103 are executed for a next target person.

For example, the effect evaluation unit 130 verifies whether or not to end the process of the target person according to a rule defined beforehand. For example, the process of the target person may be ended in a case where a calculation process of angular difference δθ ended for every target person included in the people flow. Or, the process of the target person may be ended in a case where a calculation process of angular difference δθ ended for the number of target people of a prescribed percentage of the target people included in the people flow. Or, the process of the target person may be ended in a case where a calculation process of angular difference 80 ended for the prescribed number of target people within a prescribed time. The rule defined beforehand may be any rule as long as the rule can evaluate the effect of the people flow control. A processing load of the people flow control evaluation apparatus 100 can be controlled by setting such a rule.

In step S105, the effect evaluation unit 130 evaluates by the processor 910, the effect of the people flow control using a chronological change of angular difference δθ calculated chronologically.

Specifically, the effect evaluation unit 130 determines that the target person 30 reached destination position O when the chronological change of the angular difference converges to zero. Then, the effect evaluation unit 130 evaluates the effect of the people flow control using a verification result of whether or not the target person 30 included in the people flow reached destination position O, and creates the evaluation result 43.

A right diagram of FIG. 3 is a graph showing a chronological change of angular difference δθ of a person on which control is performed at control point Pt0.

When the control is successful in the end, that is, in a case where the target person reached destination position O, the chronological change of angular difference δθ converges to zero. On the other hand, when the control fails in the end, that is, in a case where the target person could not reach destination position O, the chronological change of angular difference δθ does not converge to zero. As described, the effect evaluation unit 130 can express whether or not destination position O could be correctly reached from the control point using the chronological change of angular difference δθ.

In the left diagram of FIG. 3, for the target person represented by the solid line, the chronological change of angular difference δθ converges to zero. For the target person represented by the dotted line, the chronological change of angular difference δθ does not converge to zero. That is, the target person represented by the solid line has reached destination position O, and the target person represented by the dotted line has not reached destination position O.

For example, the effect evaluation unit 130 may evaluate the effect of the people flow control using a percentage of the number of people of which the chronological change of angular difference δθ converged to zero in the people flow. The effect evaluation unit 130 verifies how high or low the evaluation is based on a threshold set beforehand with respect to the percentage of the number of people of which the chronological change of angular difference δθ converged to zero, and creates a result of verification as the evaluation result 43. In addition, the effect of the people flow control may be evaluated in any method as long as the method is a method that can evaluate the effect of the people flow control using the chronological change of angular difference δθ.

In step S106, the effect evaluation unit 130 outputs the evaluation result 43 through the output interface 940. The effect evaluation unit 130 may output the evaluation result 43 to a display device such as the display. Or, the effect evaluation unit 130 may transmit the evaluation result 43 to a different device through the communication device 950.

### ***Description of Effect of Present Embodiment***

As described above, in the people flow control evaluation apparatus 100 according to the present embodiment, whether or not the target person included in the people flow on which the people flow control is executed reached the destination position can be expressed by the chronological change of the angular difference between a direction towards the destination and the movement direction. As a result, according to the people flow control evaluation apparatus 100 according to the present embodiment, the effect of the people flow control is possible to be evaluated more correctly.

### ***Other Configurations***

In the present embodiment, the functions of the position obtaining unit 110, the direction calculation unit 120, and the effect evaluation unit 130 are enabled by software. As a variation, the functions of the position obtaining unit 110, the direction calculation unit 120, and the effect evaluation unit 130 may be enabled by hardware.

Specifically, the people flow control evaluation apparatus 100 includes an electronic circuit 909 in place of the processor 910.

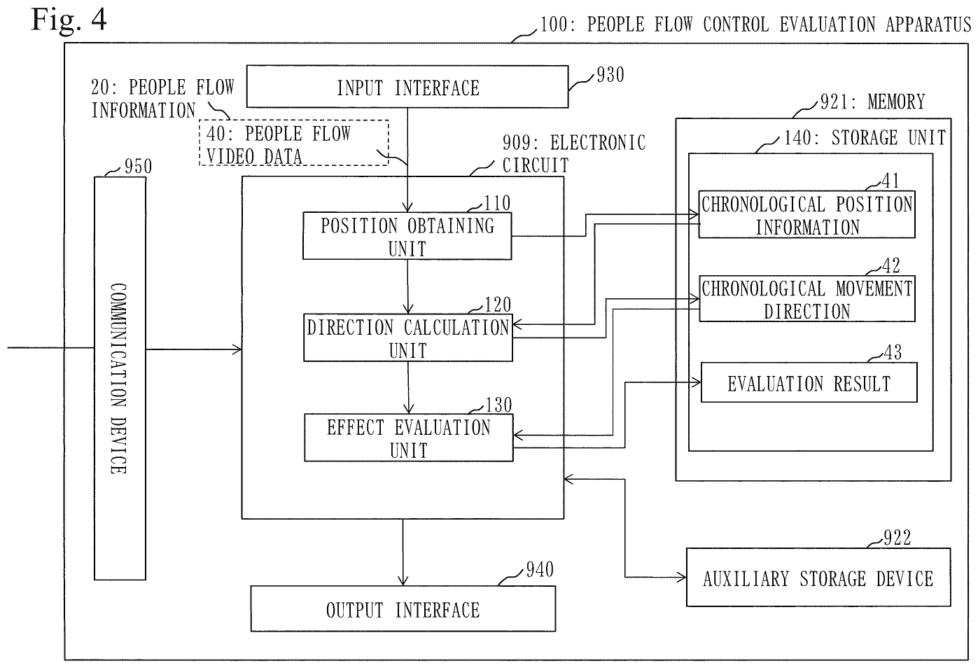

FIG. 4 is a diagram illustrating a configuration of a people flow control evaluation apparatus 100 according to a variation of the present embodiment.

The electronic circuit 909 is a dedicated electronic circuit that enables the functions of the position obtaining unit 110, the direction calculation unit 120, and the effect evaluation unit 130. The electronic circuit 909, specifically, is a single circuit, a composite circuit, a programmed processor, a parallel programmed processor, a logic IC, a GA, an ASIC, or an FPGA. GA is an abbreviation for Gate Array. ASIC is an abbreviation for Application Specific Integrated Circuit. FPGA is an abbreviation for Field-Programmable Gate Array.

The functions of the position obtaining unit 110, the direction calculation unit 120, and the effect evaluation unit 130 may be enabled by one electronic circuit or may be enabled by being distributed to a plurality of electronic circuits.

As another variation, some of the functions of the position obtaining unit 110, the direction calculation unit 120, and the effect evaluation unit 130 may be enabled by the electronic circuit and the rest of the functions may be enabled by software. Some or all of the functions of the position obtaining unit 110, the direction calculation unit 120, and the effect evaluation unit 130 may be enabled by firmware.

Each of the processor and the electronic circuit is also called processing circuitry. In other words, the functions of the position obtaining unit 110, the direction calculation unit 120, and the effect evaluation unit 130 are enabled by the processing circuitry.

### Embodiment 2

In the present embodiment, mainly differing points from Embodiment 1 and points to be added to Embodiment 1 will be described.

In the present embodiment, with regard to a configuration having same functions as the configuration in Embodiment 1, same reference signs are added, and the description will be omitted.

### ***Description of Configuration***

An example of a hardware configuration and an example of a functional configuration of a people flow control evaluation apparatus 100 according to the present embodiment are same as the example of the hardware configuration and the example of the functional configuration of Embodiment 1.

In the present embodiment, the effect evaluation unit 130 calculates an absolute value sum of angular difference δθ calculated chronologically in a case where the chronological change of angular difference δθ converges to zero. Then, the effect evaluation unit 130 uses the absolute value sum as an evaluation index that evaluates the effect of the people flow control.

### ***Description of Operation***

Next, a people flow control evaluation process that is operation of the people flow control evaluation apparatus 100 according to the present embodiment will be described. An operation procedure of the people flow control evaluation apparatus 100 is equivalent to the people flow control evaluation method. A program that enables the operation of the people flow control evaluation apparatus 100 is equivalent to the people flow control evaluation program.

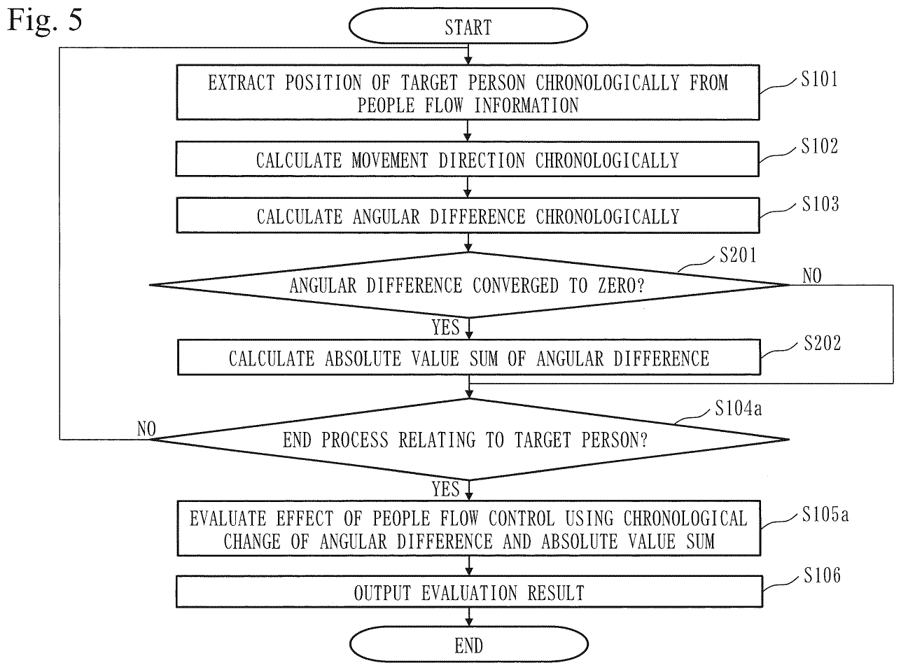

FIG. 5 is a flow diagram illustrating the operation of the people flow control evaluation apparatus 100 according to the present embodiment.

With regard to step S101 to step S103, and step S106 in the people flow control evaluation process according to the present embodiment, step S101 to step S103, and step S106 are same as S101 to step S103, and step S106 in Embodiment 1.

With regard to step S104a and step S105a, basic operation is a same as step S104 and step S105 described Embodiment 1. Differing portions will be described later.

Step S201 and step S202 are added in between step S103 and step S104a in the present embodiment.

In step S201, the effect evaluation unit 130 verifies whether or not the chronological change of angular difference δθ converges to zero, that is, whether or not the target person 30 reaches destination position O.

In a case where the chronological change of angular difference δθ converges to zero, the process proceeds to step S202.

In a case where the chronological change of angular difference δθ does not converge to zero, the process proceeds to step S104a.

In step S202, the effect evaluation unit 130 calculates an absolute value of each angular difference δθ of angular differences δθ calculated chronologically, and calculates a sum of the absolute value of each angular difference δθ as the absolute value sum.

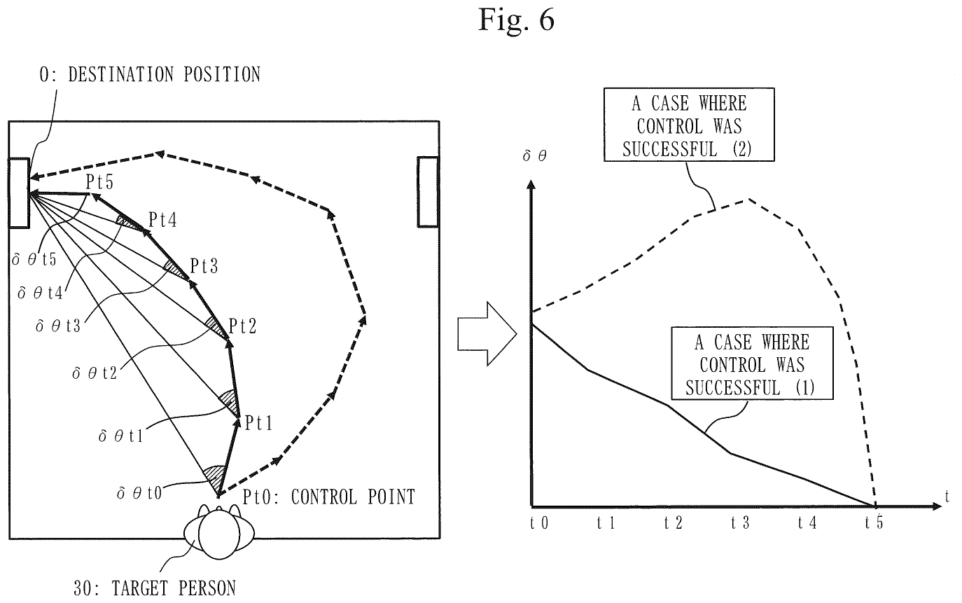

FIG. 6 is a schematic view showing the people flow control evaluation process according to the present embodiment.

In FIG. 6, both a target person of a solid line and a target person of a dotted line have reached destination position O. A route indicated by the dotted line, however, is taking a longer detour, and a people flow control effect at the control point can be considered small. To express how big or small the people flow control effect is depending on the route as described above, the absolute value of angular difference δθ calculated chronologically is calculated and an accumulation of absolute values is sought in the present embodiment. This cumulative total of the absolute values, that is, how large or small the absolute value sum is, corresponds to how large or small an area of a graph is on a right diagram of FIG. 6. In an example of FIG. 6, an absolute value sum of the target person who moved in the dotted line becomes larger compared with an absolute value sum of the target person who moved in the solid line. The effect of the people flow control becomes possible to be correctly evaluated by how large or small this absolute value sum is.

In step S104a, the effect evaluation unit 130 verifies whether or not to end the process of the target person included in the people flow.

In a case where the process of the target person is to end, the process proceeds to step S105a.

In a case where the process of the target person is not to end, the process returns to step S101, and processes from step S101 to step S202 are executed for a next target person.

For example, the effect evaluation unit 130 verifies whether or not to end the process of the target person according to a rule defined beforehand. As with Embodiment 1, for example, the process of the target person may be ended in a case where the calculation process of angular difference δθ and, if necessary, a calculation process of the absolute value sum ended for every target person included in the people flow. Or, the process of the target person may be ended in a case where the calculation process of angular difference δθ and, if necessary, the calculation process of the absolute value sum ended for the number of target people of the prescribed percentage of the target people included in the people flow. Or, the process of the target person may be ended in a case where the calculation process of angular difference δθ and, if necessary, the calculation process of the absolute value sum ended for the prescribed number of target people within the prescribed time. The rule defined beforehand may be any rule as with Embodiment 1 as long as the rule can evaluate the effect of the people flow control.

In step S105a, the effect evaluation unit 130 evaluates by the processor 910, the effect of the people flow control using the chronological change of angular difference δθ calculated chronologically, and in a case where the absolute value sum has been calculated, the absolute value sum.

The effect evaluation unit 130, for example, evaluates a control effect using, in the people flow, the percentage of the number of people of which the chronological change of angular difference δθ converged to zero and an absolute value sum of a person of which the chronological change of angular difference δθ converged to zero. For example, the effect evaluation unit 130 evaluates the control effect by a combination of the percentage of the number of people of which the chronological change of angular difference δθ converged to zero and an average of absolute value sums of the people of which the chronological change of angular difference δθ converged to zero.

More specifically, the control effect may be evaluated as “the control effect is very big” in a case where the percentage of the number of people of which the chronological change of angular difference δθ converged to zero is equal to or more than 80%, and the average of the absolute value sums of the people of which the chronological change of angular difference δθ converged to zero is equal to or less than a prescribed value. In addition, the control effect may be evaluated in any method as long as the method is a method that can evaluate the control effect using the chronological change of angular difference δθ calculated chronologically and the absolute value sum in a case where the absolute value sum is calculated.

### ***Description of Effect of Present Embodiment***

As described above, in the people flow control evaluation apparatus 100 according to the present embodiment, the effect of the people flow control is possible to be evaluated more correctly by using the absolute value sum of the angular difference until the destination position is reached as the evaluation index.

### Embodiment 3

In the present embodiment, mainly differing points from Embodiment 1 and points to be added to Embodiment 1 will be described.

In the present embodiment, with regard to a configuration having same functions as the configuration in Embodiment 1, same reference signs are added, and the description will be omitted.

### ***Description of Configuration***

An example of a hardware configuration and an example of a functional configuration of a people flow control evaluation apparatus 100 according to the present embodiment are same as the example of the hardware configuration and the example of the functional configuration of Embodiment 1.

In the present embodiment, the effect evaluation unit 130 calculates a square sum of angular difference δθ calculated chronologically in a case where the chronological change of angular difference δθ converges to zero. Then, the effect evaluation unit 130 uses the square sum as the evaluation index that evaluates the effect of the people flow control.

### ***Description of Operation***

Next, a people flow control evaluation process that is operation of the people flow control evaluation apparatus 100 according to the present embodiment will be described. An operation procedure of the people flow control evaluation apparatus 100 is equivalent to the people flow control evaluation method. A program that enables the operation of the people flow control evaluation apparatus 100 is equivalent to the people flow control evaluation program.

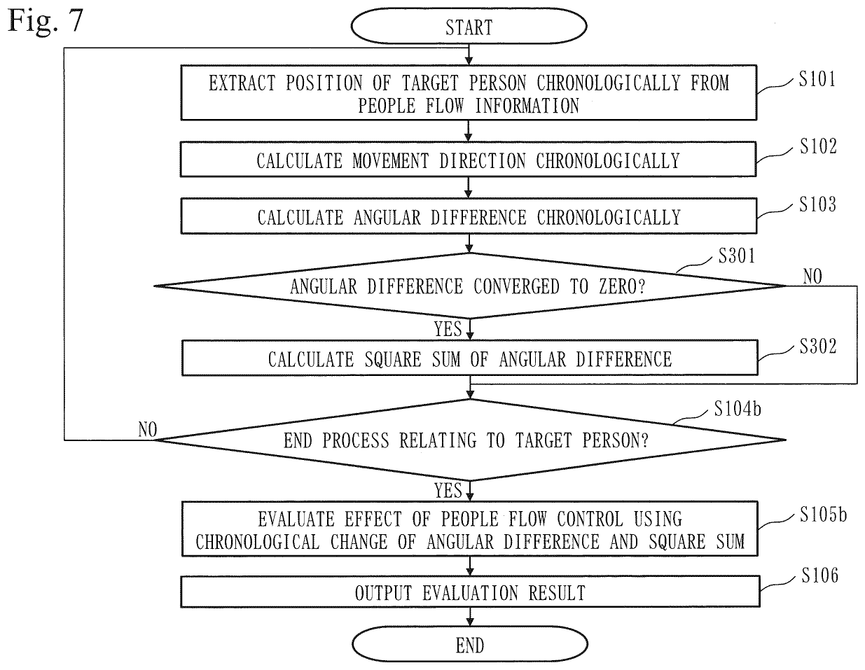

FIG. 7 is a flow diagram illustrating the operation of the people flow control evaluation apparatus 100 according to the present embodiment.

With regard to step S101 to step S103, and step S106 in the people flow control evaluation process according to the present embodiment, step S101 to step S103, and step S106 are same as S101 to step S103, and step S106 in Embodiment 1.

With regard to step S104b and step S105b, basic operation is a same as step S104 and step S105 described Embodiment 1. Differing portions will be described later.

Step S301 and step S302 are added in between step S103 and step S104b in the present embodiment.

In step S301, the effect evaluation unit 130 verifies whether or not the chronological change of angular difference δθ converges to zero, that is, whether or not the target person 30 reaches destination position O.

In a case where the chronological change of angular difference δθ converges to zero, the process proceeds to step S302.

In a case where the chronological change of angular difference δθ does not converge to zero, the process proceeds to step S104b.

In step S302, the effect evaluation unit 130 calculates a square of each angular difference of angular differences δθ calculated chronologically, and calculates a sum of the square of each angular difference as a square sum.

In FIG. 6, both the target person of the solid line and the target person of the dotted line have reached destination position O. The route indicated by the dotted line, however, is taking the longer detour, and the people flow control effect at the control point can be considered small. To express how big or small the people flow control effect is depending on the route as described above, a square of angular difference 80 calculated chronologically is calculated and an accumulation of squares is sought in the present embodiment. This cumulative total of the squares, that is, how large or small a square sum is corresponds to how large or small the area of the graph is on the right diagram of FIG. 6. In the example of FIG. 6, a square sum of the target person who moved in the dotted line becomes larger compared with a square sum of the target person who moved in the solid line. The effect of the people flow control becomes possible to be correctly evaluated by how large or small this square sum is.

In step S104b, the effect evaluation unit 130 verifies whether or not to end the process of the target person included in the people flow.

In a case where the process of the target person is to end, the process proceeds to step S105b.

In a case where the process of the target person is not to end, the process returns to step S101, and processes from step S101 to step S302 are executed for a next target person.

For example, the effect evaluation unit 130 verifies whether or not to end the process of the target person according to the rule defined beforehand. As with Embodiment 1, for example, the process of the target person may be ended in a case where the calculation process of angular difference δθ and, if necessary, a calculation process of the square sum ended for every target person included in the people flow. Or, the process of the target person may be ended in a case where the calculation process of angular difference δθ and, if necessary, the calculation process of the square sum ended for the number of target people of the prescribed percentage of the target people included in the people flow. Or, the process of the target person may be ended in a case where the calculation process of angular difference δθ and, if necessary, the calculation process of the square sum ended for the prescribed number of target people within the prescribed time. The rule defined beforehand may be any rule as with Embodiment 1 as long as the rule can evaluate the effect of the people flow control.

In step S105b, the effect evaluation unit 130 evaluates by the processor 910, the effect of the people flow control using the chronological change of angular difference δθ calculated chronologically, and in a case where the square sum has been calculated, the square sum.

The effect evaluation unit 130, for example, evaluates the control effect using, in the people flow, the percentage of the number of people of which the chronological change of angular difference δθ converged to zero and furthermore, a square sum of a person of which the chronological change of angular difference δθ converged to zero. For example, the effect evaluation unit 130 evaluates the control effect by a combination of the percentage of the number of people of which the chronological change of angular difference δθ converged to zero and an average of square sums of the people of which the chronological change of angular difference δθ converged to zero.

More specifically, the control effect is evaluated as “the control effect is very big” in a case where the percentage of the number of people of which the chronological change of angular difference δθ converged to zero is equal to or more than 80%, and the average of the square sums of the people of which the chronological change of angular difference δθ converged to zero is equal to or less than a prescribed value. In addition, the control effect may be evaluated in any method as long as the method is a method that can evaluate the control effect using the chronological change of angular difference δθ calculated chronologically and the square sum in a case where the square sum is calculated.

***Description of Effect of Present Embodiment***

As described above, in the people flow control evaluation apparatus 100 according to the present embodiment, the effect of the people flow control is possible to be evaluated more correctly by using the square sum of the angular difference until the destination position is reached as the evaluation index.

### Embodiment 4

In the present embodiment, mainly differing points from Embodiment 1 and points to be added to Embodiment 1 will be described.

In the present embodiment, with regard to a configuration having same functions as the configuration in Embodiment 1, same reference signs are added, and the description will be omitted.

***Description of Configuration***

An example of a hardware configuration and an example of a functional configuration of a people flow control evaluation apparatus 100 according to the present embodiment are same as the example of the hardware configuration and the example of the functional configuration of Embodiment 1.

In the present embodiment, the effect evaluation unit 130 calculates a degree of change of angular difference δθ calculated chronologically in a case where the chronological change of angular difference δθ converges to zero. Specifically, the effect evaluation unit 130 calculates a dissimilarity in a temporal degree of change of angular difference δθ calculated chronologically in a case where the chronological change of angular difference δθ converges to zero. Then, the effect evaluation unit 130 uses the dissimilarity in the temporal degree of change of angular difference δθ as the evaluation index that evaluates the effect of the people flow control.

### ***Description of Operation***

Next, a people flow control evaluation process that is operation of the people flow control evaluation apparatus 100 according to the present embodiment will be described. An operation procedure of the people flow control evaluation apparatus 100 is equivalent to the people flow control evaluation method. A program that enables the operation of the people flow control evaluation apparatus 100 is equivalent to the people flow control evaluation program.

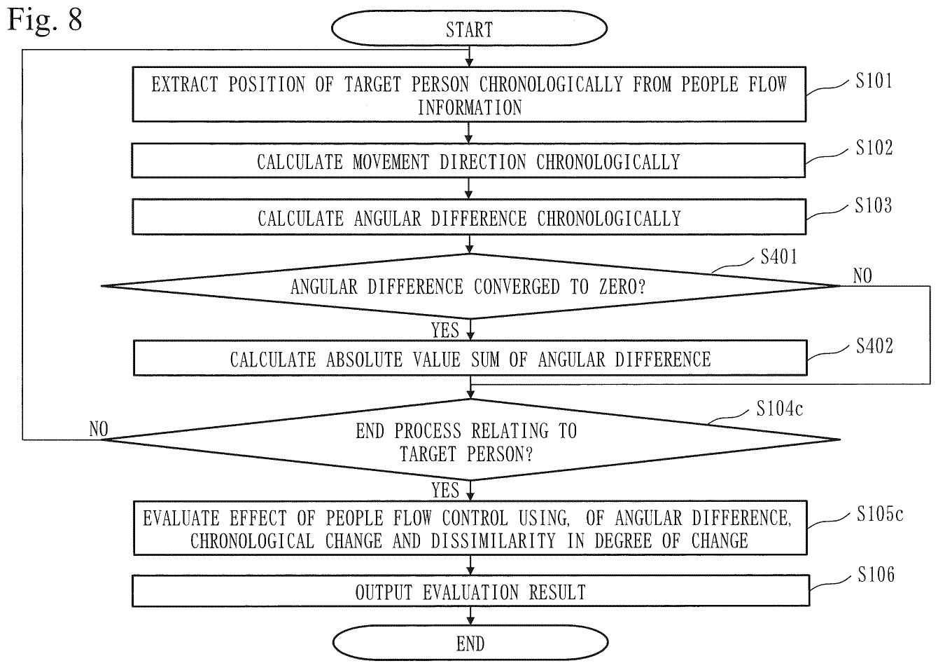

FIG. 8 is a flow diagram illustrating the operation of the people flow control evaluation apparatus 100 according to the present embodiment.

With regard to step S101 to step S103, and step S106 in the people flow control evaluation process according to the present embodiment, step S101 to step S103, and step S106 are same as S101 to step S103, and step S106 in Embodiment 1.

With regard to step S104c and step S105c, basic operation is a same as step S104 and step S105 described in Embodiment 1. Differing portions will be described later.

Step S401 and step S402 are added in between step S103 and step S104c in the present embodiment.

In step S401, the effect evaluation unit 130 verifies whether or not the chronological change of angular difference δθ converges to zero, that is, whether or not the target person 30 reaches destination position O.

In a case where the chronological change of angular difference δθ converges to zero, the process proceeds to S402.

In a case where the chronological change of angular difference δθ does not converge to zero, the process proceeds to step S104c.

In step S402, the effect evaluation unit 130 calculates the dissimilarity in the temporal degree of change of angular difference δθ calculated chronologically.

In FIG. 6, both the target person of the solid line and the target person of the dotted line have reached destination position O. The route indicated by the dotted line, however, is taking a longer detour. This can be considered that in a person movement of the dotted line, the control effect at the control point showed with elapsed time. To express that the control effect at the control point showed with the elapsed time as described above, the angular difference is calculated chronologically (step S103), an amount of change of the angular difference is observed, and a threshold process set beforehand is performed in the present embodiment. For example, in a case where the angle suddenly changed from a large angle to a small angle, it can be considered that an effect of the control is produced at that timing. As described above, the effect of the control becomes possible to be correctly evaluated by a threshold process of an angle change.

In step S104c, the effect evaluation unit 130 verifies whether or not to end the process of the target person included in the people flow.

In a case where the process of the target person is to end, the process proceeds to step S105c.

In a case where the process of the target person is not to end, the process returns to step S101, and processes from step S101 to step S402 are executed for a next target person.

For example, the effect evaluation unit 130 verifies whether or not to end the process of the target person according to the rule defined beforehand. As with Embodiment 1, for example, the process of the target person may be ended in a case where the calculation process of angular difference δθ and, if necessary, a calculation process of the dissimilarity in the temporal degree of change of angular difference δθ ended for every target person included in the people flow. Or, the effect evaluation unit 130 may end the process of the target person in a case where the calculation process of angular difference δθ and, if necessary, the calculation process of the dissimilarity in the temporal degree of change of angular difference δθ ended for the number of target people of the prescribed percentage of the target people included in the people flow. Or, the process of the target person may be ended in a case where the calculation process of angular difference δθ and, if necessary, the calculation process of the dissimilarity in the temporal degree of change of angular difference δθ ended for the prescribed number of target people within the prescribed time. The rule defined beforehand may be any rule as with Embodiment 1 as long as the rule can evaluate the effect of the people flow control.

In step S105c, the effect evaluation unit 130 evaluates by the processor 910, the effect of the people flow control using the chronological change of angular difference δθ calculated chronologically, and in a case where the dissimilarity in the temporal degree of change of angular difference δθ has been calculated, the dissimilarity in the degree of change.

The effect evaluation unit 130, for example, evaluates the control effect using, in the people flow, the percentage of the number of people of which the chronological change of angular difference δθ converged to zero and furthermore, a dissimilarity in the temporal degree of change of angular difference δθ of a person of which the chronological change of angular difference δθ converged to zero.

For example, the effect evaluation unit 130 evaluates that “the people flow control effect is big” when the percentage of the number of people of which the chronological change of angular difference δθ converged to zero is equal to or more than 80%, and identifies a timing when an effect showed by a threshold process of the dissimilarity in the temporal degree of change of angular difference δθ. Then, the effect evaluation unit 130 creates the evaluation result 43 that says “the people flow control effect is big, and the effect can be shown more at a certain timing” with regard to the people flow control. In addition, the control effect may be evaluated in any method as long as the method is a method that can evaluate the control effect using the chronological change of angular difference δθ calculated chronologically and the threshold process of the dissimilarity in the temporal degree of change of angular difference δθ.

### ***Description of Effect of Present Embodiment***

As described above, in the people flow control evaluation apparatus 100 according to the present embodiment, the effect of the people flow control is possible to be evaluated in more detail using the threshold process of the dissimilarity in the temporal degree of change of angular difference δθ.

In Embodiments 1 to 4 above, each unit of the people flow control evaluation apparatus has been described as an independent functional block. The configuration of the people flow control evaluation apparatus, however, does not have to be in the configuration as in the embodiments mentioned above. The functional block of the people flow control evaluation apparatus may be in any configuration as long as the functions described in the embodiments mentioned above can be enabled. The people flow control evaluation apparatus may be a system configured of a plurality of devices, not of one device.

Of Embodiments 1 to 4, a plurality of portions may be combined and executed. Or, of these embodiments, one portion may be executed. In addition, these embodiments may be combined and executed in any manner, either fully or partially.

That is, in Embodiments 1 to 4, a free combination of each embodiment, or a variation of any element in each embodiment, or omitting of any element in each embodiment is possible.

The embodiments mentioned above are essentially preferred examples, and are not intended to limit the scope of the present disclosure, the scope of application of the present disclosure, and the scope of use of the present disclosure. Various changes are possible to be made to the embodiments mentioned above as necessary. For example, the procedures described using the flow diagrams and sequence diagrams may suitably be changed.

### REFERENCE SIGNS LIST

20: people flow information; 30: target person; 40: people flow video data; 41: chronological position information; 42: chronological movement direction; 43: evaluation result; 100: people flow control evaluation apparatus; 110: position obtaining unit; 120: direction calculation unit; 130: effect evaluation unit; 140: storage unit; 909: electronic circuit; 910: processor; 921: memory; 922: auxiliary storage device; 930: input interface; 940: output interface; 950: communication device.

1. A people flow control evaluation apparatus that evaluates an effect of people flow control that controls people flow towards a destination position, the people flow control evaluation apparatus comprising:
processing circuitry to:
extract a position of a target person who is a person included in the people flow chronologically from people flow information that shows people flow on which the people flow control is executed, and store the position of the target person extracted chronologically as chronological position information,
calculate a movement direction of the target person chronologically based on the chronological position information, and store the movement direction of the target person calculated chronologically as a chronological movement direction, and
calculate an angular difference between the movement direction of the target person and a direction towards the destination position from the position of the target person chronologically based on the destination position and the chronological movement direction, determine whether or not the target person reached the destination position using a chronological change of the angular difference calculated chronologically, and evaluate the effect of the people flow control using a verification result of whether or not the target person reached the destination position.

2. The people flow control evaluation apparatus according to claim 1, wherein
the processing circuitry
determines that the target person reached the destination position when the chronological change of the angular difference converges to zero.

3. The people flow control evaluation apparatus according to claim 2, wherein
the processing circuitry
calculates an absolute value sum of the angular difference calculated chronologically in a case where the chronological change of the angular difference converges to zero, and uses the absolute value sum as an evaluation index that evaluates the effect of the people flow control.

4. The people flow control evaluation apparatus according to claim 2, wherein
the processing circuitry
calculates a square sum of the angular difference calculated chronologically in a case where the chronological change of the angular difference converges to zero, and uses the square sum as an evaluation index that evaluates the effect of the people flow control.

5. The people flow control evaluation apparatus according to claim 2, wherein
the processing circuitry
calculates a dissimilarity in a temporal degree of change of the angular difference calculated chronologically in a case where the chronological change of the angular difference converges to zero, and uses the dissimilarity in the temporal degree of change of the angular difference calculated as an evaluation index that evaluates the effect of the people flow control.

6. The people flow control evaluation apparatus according to claim 1, wherein
the people flow information is people flow video data that is the people flow filmed.

7. The people flow control evaluation apparatus according to claim 2, wherein
the people flow information is people flow video data that is the people flow filmed.

8. The people flow control evaluation apparatus according to claim 3, wherein
the people flow information is people flow video data that is the people flow filmed.

9. The people flow control evaluation apparatus according to claim 4, wherein
the people flow information is people flow video data that is the people flow filmed.

10. The people flow control evaluation apparatus according to claim 5, wherein
the people flow information is people flow video data that is the people flow filmed.

11. A people flow control evaluation method that is used in a people flow control evaluation apparatus that evaluates an effect of people flow control that controls people flow towards a destination position, the people flow control evaluation method comprising:
extracting a position of a target person who is a person included in the people flow chronologically from people flow information that shows people flow on which the people flow control is executed, and storing the position of the target person extracted chronologically as chronological position information;
calculating a movement direction of the target person chronologically based on the chronological position information, and storing the movement direction of the target person calculated chronologically as a chronological movement direction; and
calculating an angular difference between the movement direction of the target person and a direction towards the destination position from the position of the target person chronologically based on the destination position and the chronological movement direction, determining whether or not the target person reached the destination position using a chronological change of the angular difference calculated chronologically, and evaluating the effect of the people flow control using a verification result of whether or not the target person reached the destination position.

12. A non-transitory computer readable medium storing a people flow control evaluation program that is used in a people flow control evaluation apparatus that evaluates an effect of people flow control that controls people flow towards a destination position, the people flow control evaluation program causing a computer to execute:
a position obtaining process to extract a position of a target person who is a person included in the people flow chronologically from people flow information that shows people flow on which the people flow control is executed, and to store the position of the target person extracted chronologically as chronological position information;
a direction calculation process to calculate a movement direction of the target person chronologically based on the chronological position information, and to store the movement direction of the target person calculated chronologically as a chronological movement direction; and
an effect evaluation process to calculate an angular difference between the movement direction of the target person and a direction towards the destination position from the position of the target person chronologically based on the destination position and the chronological movement direction, to determine whether or not the target person reached the destination position using a chronological change of the angular difference calculated chronologically, and to evaluate the effect of the people flow control using a verification result of whether or not the target person reached the destination position.
